(19) United States
(12) Patent Application Publication
(10) Pub. No.: US 2004/0034874 A1
(43) Pub. Date: Feb. 19, 2004

(54) Pop-up PVR advertising

(76) Inventors: Phillip M. Hord, Lilburn, GA (US); Dean P. Jagels, Dacula, GA (US)

Correspondence Address: SCIENTIFIC-ATLANTA, INC., INTELLECTUAL PROPERTY DEPARTMENT, 5030 SUGARLOAF PARKWAY, LAWRENCEVILLE, GA, 30044, US

(21) Appl. No.: 10/223,171

(22) Filed: Aug. 19, 2002

(51) Int. Cl. H04N 7/16; H04N 7/10; H04N 7/025

(52) U.S. Cl. 725/136; 725/32; 725/36

(57) ABSTRACT

A system for presenting advertisements to a user during video presentations is described. The system includes a memory with logic and a processor configured with the logic to detect a trick mode activation during a media content instance presentation and then present an advertisement during a trick mode display of the media content instance presentation.

### TECHNICAL FIELD

The present invention is generally related to television systems, and, more particularly, is related to interactive television.

### BACKGROUND OF THE INVENTION

With recent advances in digital transmission technology, subscriber television systems are now capable of providing much more than the traditional analog broadcast video. In implementing enhanced programming, the home communication terminal device (“HCT”), otherwise known as the set-top box, has become an important computing device for accessing media content services (and media content within those services) and navigating a user through a maze of available services. In addition to supporting traditional anlog broadcast video functionality, digital HCTs (or “DHCTs”) now also support an increasing number of two-way digital services such as video-on-demand and personal video recording.

Typically, a DHCT is connected to a cable or satellite, or generally, a subscriber television system, and includes hardware and software necessary to provide the functionality of the digital television system at the user's site. Some of the software executed by a DHCT can be downloaded and/or updated via the subscriber television system. Each DHCT also typically includes a processor, communication components, and memory, and is connected to a television or other display device, such as a personal computer. While many conventional DHCTs are stand-alone devices that are externally connected to a television, a DHCT and/or its functionality may be integrated into a television or personal computer or even an audio device such as a programmable radio, as will be appreciated by those of ordinary skill in the art.

Trick mode functionality (e.g., pause, fast forward, rewind, skip ahead, or skip back functionality), whether implemented in a network-based infrastructure (e.g., media-on-demand) or a customer premise based infrastructure (DHCTs equipped with persistent storage devices), provides users with the opportunity to enhance the control of their viewing experience. However, trick mode functionality also provides the user with the ability to bypass commercials and other media content, which removes a potentially important source of information from the user and reduces the attractiveness of subscriber television systems as media for advertising. Thus, a heretofore unaddressed need exists in the industry to address the aforementioned and/or other deficiencies and inadequacies.

### BRIEF DESCRIPTION OF THE DRAWINGS

The preferred embodiments of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram of an example subscriber television system (STS), in accordance with one embodiment of the invention.

FIG. 2 is a block diagram of an example headend as depicted in FIG. 1 and related equipment, in accordance with one embodiment of the invention.

FIG. 3 is a block diagram of an example DHCT as depicted in FIG. 1 and related equipment, in accordance with one embodiment of the invention.

FIG. 4 is a schematic diagram of an example remote control device to provide input to the DHCT illustrated in FIG. 3, in accordance with one embodiment of the invention.

FIGS. 5A-5C are screen diagrams of example trick mode displays that include advertisements, in accordance with several embodiments of the invention.

FIGS. 6A-6B are timing diagrams of example trick mode advertisement insertion mechanisms, in accordance with several embodiments of the invention.

FIGS. 7A-7B are block diagrams of example decision data that can be used by the preferred embodiments of the invention to make a determination as to the type of advertisement to insert into the trick mode display, and the manner of presenting it, in accordance with one embodiment of the invention.

FIGS. 8A-8B are flow diagrams of some example methods of the preferred embodiments for presenting advertisements during trick mode displays, in accordance with two embodiments of the invention.

### DETAILED DESCRIPTION OF THE PREFERRED EMBODIMENTS

The preferred embodiments of the invention now will be described more fully hereinafter with reference to the accompanying drawings, in which preferred embodiments of the invention are shown. The preferred embodiments of the invention include systems and methods for presenting advertising during video presentations that are displayed during the activation of trick modes. Trick modes are herein understood to include pause, fast forward, rewind, skip ahead, and skip back functionality. Trick mode displays include the display of the media content instance triggered by the activation of the trick mode (and generated using video and/or audio signals), wherein the triggering event occurs during the presentation of that media content instance, and lasting until the trick mode has been terminated. Thus, the trick mode display includes the media content instance video, audio, and/or data the user is presented with during pause, fast forward, rewind, skip ahead, or skip back operations. Trick modes are typically invoked in response to a user pressing a button on an input device such as a remote control device. In the preferred embodiments, trick mode activation is detected, and then responsively, a trick mode display is generated with advertising inserted in the video as an overlay or presented as an audio advertisement.

One way of understanding the preferred embodiments of the invention includes viewing them within the context of a subscriber television system that includes a headend that provides media content (herein understood to include video, audio, and/or data in the format of on-demand or broadcast movies, shows, commercials, or other visual images or sound) to one or more media client devices, such as a digital home communication terminal (DHCT), among others. Since the preferred embodiments of the invention can be embodied, in part or in whole, at the headend (or at a node or hub that includes headend functionality) and/or at the DHCT, example headend and DHCT embodiments are described for providing advertisements during a trick mode display.

Following the description of the components of the subscriber television system is a description of some example trick mode displays with overlaid advertisements. This description is followed by a discussion of some trick mode advertisement insertion mechanisms in various trick mode infrastructures, followed by a discussion on how to decide on the type of advertisement to display, as well as how to present it. Finally, example flow charts of some methods of the preferred embodiments are described.

The preferred embodiments of the invention may, however, be embodied in many different forms and should not be construed as limited to the embodiments set forth herein; rather, these embodiments are provided so that this disclosure will be thorough and complete, and will fully convey the scope of the invention to those having ordinary skill in the art. Furthermore, all “examples” given herein are intended to be non-limiting, and are provided as an exemplary list among many other examples contemplated but not shown.

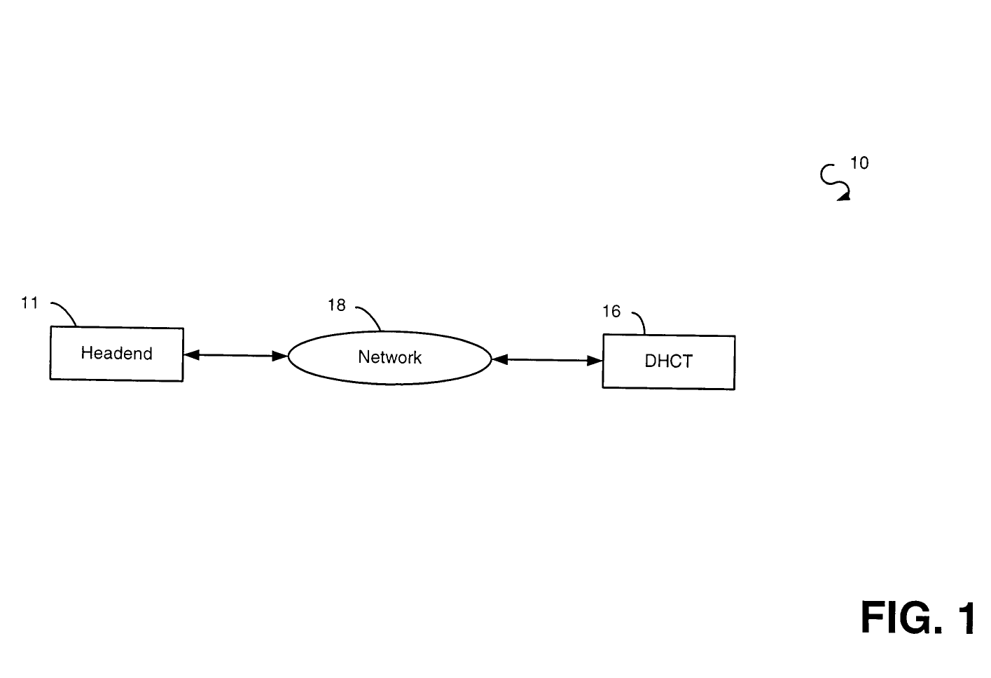

FIG. 1 is a block diagram depicting a non-limiting example of a subscriber television system (STS) 10. In this example, the STS 10 includes a headend 11 and a digital home communication terminal (DHCT) 16 that are coupled via a communications network 18. It will be appreciated that the STS 10 shown in FIG. 1 is merely illustrative and should not be construed as implying any limitations upon the scope of the preferred embodiments of the invention. For example, although single components (e.g., a headend and a DHCT) are illustrated in FIG. 1, the STS 10 can feature a plurality of any one of the illustrated components, or may be configured with alternative embodiments for any one of the individual components or with yet other additional components not enumerated above. Subscriber television systems also included within the scope of the preferred embodiments of the invention include systems not utilizing physical structured cabling for transmission, such as, but not limited to, satellite systems.

A DHCT 16 is typically situated at the residence or place of business of a user and may be a stand-alone unit or integrated into another device such as, for example, a television set or a personal computer or other display devices, or an audio device, among others. The customer's premises may be a user's residence or place of business. The DHCT 16 receives media content from the headend 11 through the network 18 and preferably provides reverse information to the headend 11 through the network 18.

The headend 11 receives media content from one or more content providers (not shown). Input signals that carry the media content may be transmitted from sources to the headend 11 via a variety of transmission paths, including satellites (not shown), and terrestrial broadcast transmitters and antennas (not shown). The headend 11 can include one or more server devices (not shown) for providing video, audio, and/or data to media client devices such as the DHCT 16. The headend 11 and the DHCT 16 cooperate to provide a user with television services via the television (not shown). The television services may include, for example, broadcast television services, cable television services, premium television services, video-on-demand (VOD) services, and/or pay-per-view (PPV) services, among others.

The STS 10 (FIG. 1) can simultaneously support a number of transmission signal types, transmission rates, and modulation formats. The ability to carry analog and digital signals over a large bandwidth is a characteristic of a hybrid fiber/coax (HFC) network typically employed in an STS, as in the STS 10 of FIG. 1. As will be appreciated by those of ordinary skill in the art, analog and digital signals in HFC networks can be multiplexed using Frequency Division Multiplexing (FDM), which enables many different types of signals to be transmitted over the STS 10 to the DHCT 16. The downstream direction transmission signals, having been multiplexed, and in one embodiment using FDM, are often referred to as in-band transmission signals and include analog transmission signals (ATSs) and digital transmission signals (DTSs). These transmission signals carry video, audio, and/or data services. The ATSs and the DTSs each typically occupy 6 MHz of the radio frequency (RF) spectrum.

However, the DTSs are digital transmission signals consisting of 64- or 256-Quadrature Amplitude Modulated (QAM) digital signals preferably formatted using Moving Picture Experts Group (MPEG) standards such as MPEG-2 transport streams, allocated in a separate frequency range. The MPEG-2 transport stream enables transmission of a plurality of DTS types over each 6 megahertz (MHz) RF subdivision, as compared to a 6 MHz ATS. MPEG-2 transport may be used to multiplex video, audio, and data in each of these DTSs. However, because an MPEG-2 transport stream allows for multiplexed video, audio, and data into the same stream, the DTSs do not necessarily have to be allocated in separate 6 MHz RF frequencies, unlike ATSs, in one embodiment. On the other hand, each DTS is capable of carrying multiple broadcast digital media content instances, multiple cycling data carousels containing broadcast data, and data requested on-demand by the subscriber.

Data is formatted, such as in Internet Protocol (IP), mapped into MPEG-2 packets, and inserted into the multiplexed MPEG-2 transport stream. Each 6 MHz RF subdivision assigned to a DTS can carry the video and audio streams of the media content instances of multiple television (TV) stations, as well as media content and data that is not necessarily related to those TV media content instances, as compared to one TV channel broadcast over one ATS that consumes the entire 6 MHz. The digital data is inserted into MPEG transport streams carried through each 6 MHz frequency subdivision assigned for digital transmission, and then demultiplexed at the subscriber DHCT so that multiple sets of data can be produced within each tuned 6 MHz frequency span, or subdivision.

The preferred embodiments of the invention include systems and methods for presenting advertising in trick mode displays in the context of network based trick mode infrastructures (e.g., as implemented via media-on-demand (MOD) mechanisms) and customer premise trick mode infrastructures (e.g., as implemented via DHCT resident, personal video recording (PVR) mechanisms). An example headend will be described, followed by a description for an example DHCT to provide the basis for later discussion on different trick mode implementations.

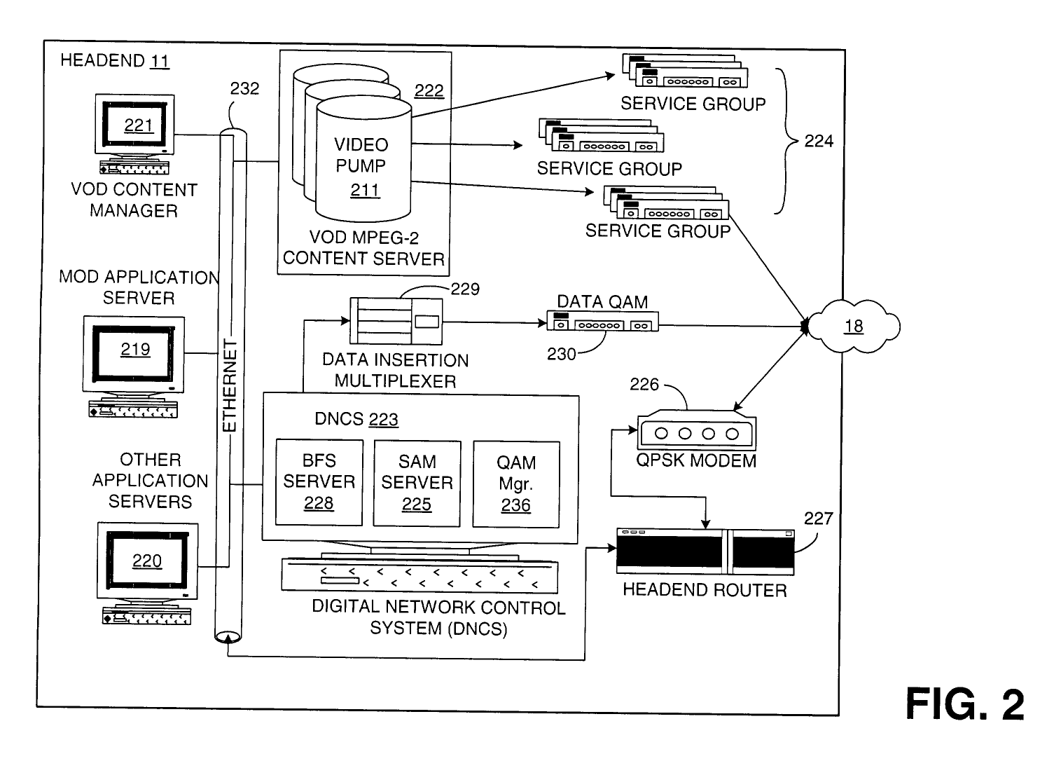

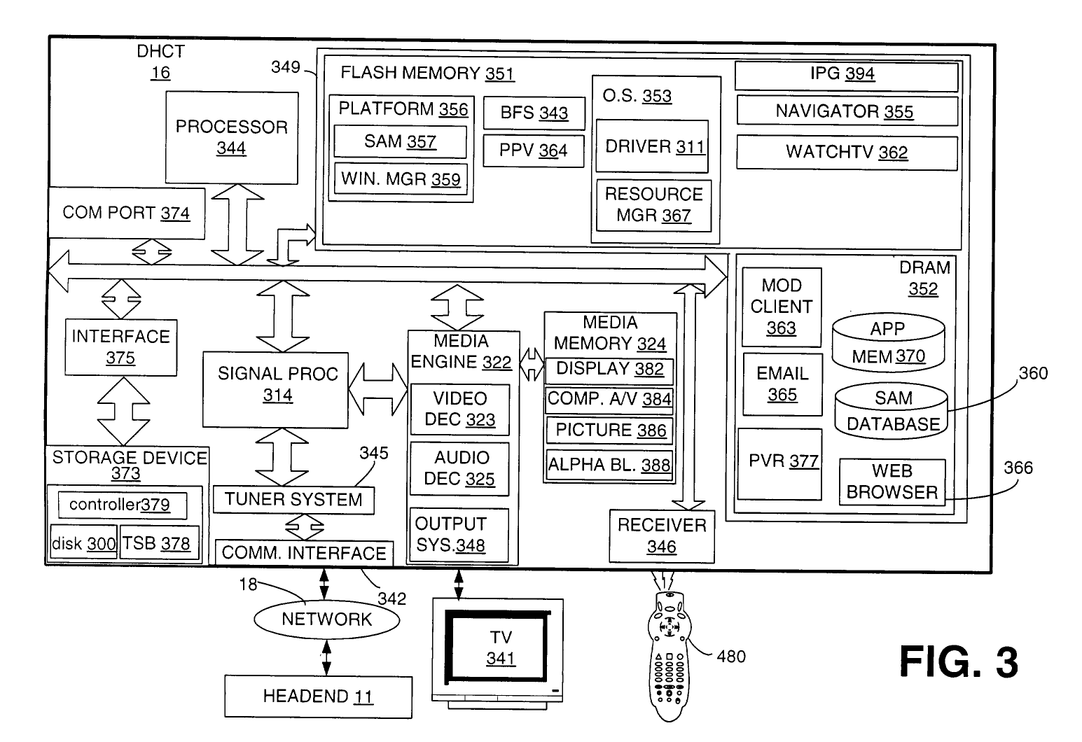

FIG. 2 is a block diagram of portions of one example headend 11 that is configured to provide broadcast and MOD services, in accordance with one embodiment of the present invention. The overview of FIG. 2 is equally applicable to one example hub, and the same elements and principles may be implemented at a hub instead of the headend 11 as described herein. It will be understood that the headend 11 shown in FIG. 2 is merely illustrative and should not be construed as implying any limitations upon the scope of the present invention. The MOD application server 219 and a plurality of other application servers 220 are connected to a digital network control system (DNCS) 223 via a high-speed network such as an Ethernet connection 232. The MOD application server 219 is responsible for reserving and configuring system resources needed to provide MOD services and for providing configuration and service data to a MOD application 363 (FIG. 3). While video is primarily referenced herein as the media content presented, it should be understood that various other types of media content are also considered to be within the scope of the preferred embodiments.

The DNCS 223 provides management, monitoring, and control of the network's elements and broadcast services provided to users. In one implementation, the DNCS 223 uses a data insertion multiplexer 229 and a data QAM 230 to insert in-band broadcast file system (BFS) data into an MPEG-2 transport stream that is broadcast and received via the DHCT's communication interface 342 (FIG. 3) and tuner system 345 (FIG. 3). The DNCS 223 also contains session management functionality, and preferably uses the Digital Storage Media Command and Control (DSM-CC) protocol to set up and maintain MOD sessions. The DNCS 223 preferably processes user to network (U-N) session signaling messages, manages allocation of session-related network resources, supports network management operations, acts as a point of contact to the network for the DHCTs 16 in the network 18 to establish individual sessions, and supports MOD services by providing the signaling interface to establish, maintain and release client initiated exclusive sessions. Further information on session set-up protocol for connection oriented data communications, such as DSM-CC, can be found in ISO/IEC 13818-6:1998, and Session Protocol by Time Warner Cable, Version 1.0, Jun. 10, 1999, both herein incorporated by reference. Also included within the DNCS 223 is a QAM manager 236, which is used to provide an interface for communications between the DNCS 223 and a QAM of the service (or QAM) groups 224.

A service application manager (SAM) server 225 is a server component of a client-server pair of components, with the client component being located at the DHCT 16 (FIG. 3). Together, the client-server SAM components provide a system in which the user can access services.

Applications on both the headend 11 and the DHCT 16 (FIG. 3) can access the data stored in a broadcast file system (BFS) server 228. The BFS server 228 is a part of a broadcast file system that has a counterpart BFS client module 343 (FIG. 3) in a DHCT 16 connected to the network 18. The BFS server 228 repeatedly sends data for applications on a data carousel (not shown) over a period of time in cyclical repeated fashion so that a DHCT 16 that is in need of reading any particular data file or parts thereof may receive it when requested by a user or one or more of its internal running processes.

A VOD content manager 221 is responsible for managing the content on the video pumps 211 of the VOD content servers 222. The MOD application server 219 controls both the VOD content manager 221 and the VOD content servers 222 and utilizes them to help deliver the video and audio streams that make up VOD services. In one embodiment, an MOD content manager and MOD content servers (not shown) could run respectively in parallel to the VOD content manager 221 and VOD content servers 222 to manage other types of on-demand media content. In an alternate embodiment an MOD content manager replaces the VOD content manager 221 and MOD content servers replaces the VOD content servers 222. The QAM modulators that comprise the QAM group 224 receive the MPEG-2 transport streams from the VOD content servers 222, convert them into encrypted RF signals at a specified frequency (channel), and transmit them to a DHCT 16 (FIG. 3) via the network 18.

The quadrature phase-shift keying (QPSK) modem 226 is responsible for transporting the out-of-band IP datagram traffic between the distribution headend 11 and a DHCT 16 (FIG. 3). Data from the QPSK modem 226 is routed by a headend router 227 within the headend 11. The headend router 227 is also responsible for delivering upstream application traffic to the various application servers, for example application servers 219 and 220.

FIG. 3 is a block diagram illustration of an example DHCT 16 that is coupled to a headend 11 and to a television 341, in accordance with one embodiment of the invention. It will be understood that the DHCT 16 shown in FIG. 3 is merely illustrative and should not be construed as implying any limitations upon the scope of the preferred embodiments of the invention. For example, some of the functionality performed by applications executed in the DHCT 16 (such as an MOD application 363) may instead be performed completely or in part at the headend 11 and vice versa, or not at all in some embodiments. The DHCT 16 preferably includes a communications interface 342 for receiving signals (video, audio and/or other data) from the headend 11 through the network 18 and for providing reverse information to the headend 11 through the network 18.

The DHCT 16 preferably includes one or more processors, such as processor 344, for controlling operations of the DHCT 16, an output system 348 (in one implementation integrated with a media engine 322) for driving the television display 341, and a tuner system 345 for tuning into a particular television channel or frequency to display media content and for sending and receiving various types of data or media content to and from the headend 11. The DHCT 16 may include, in other embodiments, multiple tuners for receiving downloaded (or transmitted) media content. The tuner system 345 enables the DHCT 16 to tune to downstream media and data transmissions, thereby allowing a user to receive digital and/or analog media content delivered in the downstream transmission via the subscriber television system. The tuner system 345 includes, in one implementation, an out-of-band tuner for bi-directional QPSK data communication and one or more QAM tuners (in band) for receiving television signals. Additionally, a receiver 346 receives externally generated information, such as user inputs or commands from an input device, such as a remote control device 480, or other devices.

The DHCT 16 processes analog and/or digital transmission signals for storage in the storage device 373, and/or for display to the television 341. The DHCT 16 preferably includes a signal processing system 314, the media engine 322, and a media memory 324. The components of the signal processing system 314 are capable of QAM demodulation, forward error correction, and demultiplexing of MPEG-2 transport streams, and parsing of elementary streams and packetized elementary streams. Additional components not shown include an analog decoder and compression engine for processing an analog transmission signal and, in one implementation, converting it to compressed audio and video streams that are produced in accordance with the syntax and semantics of a designated audio and video coding method, such as that specified by the MPEG-2 audio and MPEG-2 video ISO (International Organization for Standardization or ISO) standard.

The signal processing system 314 outputs packetized compressed streams and presents them as input for storage in the storage device 373 via an interface 375, or in other implementations, as input to the media engine 322 for decompression by a video decompression engine 323 (or video decoder) and an audio decompression engine 325 (or audio decoder), in cooperation with media memory 324, for display on the TV 341 via the output system 348. One having ordinary skill in the art will appreciate that the signal processing system 314 will preferably include other components not shown, including memory, decryptors, samplers, digitizers (e.g., analog-to-digital converters), and multiplexers, among other components. Further, it will be understood that one or more of the components listed above will interface with the processor 344 and/or system memory 349 (and/or dedicated memory for a particular component) to facilitate data transfer and/or processing of the video and/or audio signal for display and/or storage.

Under control of software applications executing from system memory 349, the processor 344 generates graphical and textual data and stores them in system memory 349. The textual and graphical data may, for example, be generated for the purposes of presenting advertisements in a trick mode display. In one example network based trick mode implementation, the MOD application 363 receives data from the headend 11 (e.g., carried in an advertising PID in one implementation) that can be used by the textual and graphical processing functionality of the DHCT 16 to create textual or graphical advertisement images. The advertisement data can be stored by the MOD application 363 in memory 349, and then inserted upon indication of a trick mode operation. In another network based trick mode implementation, the advertisements can be carried as one or more MPEG frames (encoded with the trick mode video and stored at a video pump 211 (FIG. 2)) and processed like any other video signal at the DHCT 16. In customer premise based trick mode implementations (i.e., where trick modes are enabled through the internal PVR mechanisms of the DHCT 16), the advertisement data can be stored, in cooperation with the PVR application 377, in a storage device 373, and advertisements can be inserted via the PVR application 377.

As described above, data for generating the graphical and/or textual objects may be provided, in one implementation, by the headend 11 and stored in the storage device 373 or system memory 349, and then retrieved by the processor 344 and manipulated in cooperation with system memory 349 (e.g., DRAM 352). After generating graphical and/or textual objects, the processor 344 then notifies the media engine 322 of the pending data that is to be transferred to media memory 324. The media engine 322 may be, for example, an application specific integrated circuit (ASIC).

The processor 344 runs an operating system 353 capable of multi-tasking, task scheduling and switching. The processor 344 can be notified by the media engine 322 via interrupts or messages written to registers when the processor 344 is entitled access to media memory 324. A background task is preferably executed to poll messages on a periodic basis. The processor 344 may postpone a current task in order to transfer data from system memory 349 to media memory 324. Small sets of contiguous memory locations are read rapidly from system memory 349 and stored in first-in-first-out (FIFO) memory (not shown) in the media engine 322.

Communication aimed at transferring data from system memory 349 to media memory 324 preferably includes specifying the data to be transferred, including the number of data sets and total number of bytes to be transferred. Each data set occupies a rectangular region to be copied within the confines of a display buffer 382. Thus, a data set specification includes the location of the top-left pixel of a rectangle in relation to the top-left pixel of the graphics overlay (for example, the overlay of the advertisement), the number of bytes in each horizontal line of the rectangle, and the number of lines in the rectangle.

Sections of media memory 324 include one or more of the following modules: a compressed video and audio (A/V) buffer 384, a picture buffer 386, a display buffer 382, an alpha blend plane 388, and an off-screen buffer (not shown) and an audio buffer (not shown). Although shown as a single buffer, the compressed A/V buffer 384 preferably uses a separate buffer for the video and a separate buffer for the audio. Compressed MPEG-2 video streams and compressed digital audio streams are stored in the compressed A/V buffer 384. The audio buffer stores decompressed audio that is to be fed into audio digital-to-analog converters (DACs, not shown). The picture buffer 386 has a capacity equal to the number of bytes in a reconstructed MPEG-2 Picture. One picture buffer may store a past reference picture (such as an I frame, i.e. an intra-coded picture that is encoded in a manner such that it can be decoded by an MPEG decoder without reference to other pictures or frames, as is well-known to those skilled in the art), a second picture buffer may store a future reference picture (such as a P frame) and a third picture buffer may store a picture that is currently being decompressed (such as, for example, a B frame).

The display buffer 382 may contain graphical and textual data produced by the processor 344 as well as downscaled digital video data. The content of the display buffer 382 (also referred to as the graphics overlay) may be overlaid on top of a video picture. An alpha-blend-plane 388 stores pixel values that correspond spatially to respective pixel data in the graphics overlay. A pixel value in the alpha-blend-plane 388 indicates (according to an alpha value) the extent to which a corresponding “pixel” in the display buffer 382 will be opaque. In other words, the values in an alpha-blend-plane 388 determine the extent to which a graphics overlay is translucent. For example, the alpha-blend-plane 388 may contain values corresponding to a graphics overlay containing a textual advertisement, where high alpha values would cause the advertisement to appear opaque and intermediate alpha values would cause the advertisement to appear translucent. The color depth and spatial resolution employed for the graphics overlay affect the number of bytes and bus bandwidth consumed by the display buffer 382 and alpha-blend-plane 388.

External operations (e.g., by the processor 344) deposit the compressed MPEG-2 video stream and compressed audio streams respectively into the compressed ANV buffer 384. The compressed A/V buffer 384 is preferably a circular buffer entity filled by external operations and consumed respectively by the video decoder 323 and audio decoder 325. Each compressed MPEG-2 video picture in the compressed A/V buffer 384 is preferably specified compliant to the video syntax and semantics rules of the MPEG-2 standard, as would be understood by one reasonably skilled in the art. Information specified according to the MPEG-2 video stream syntax at the picture level of each compressed picture is read by the video decoder 323. For instance, information specified within the picture header and the picture coding extension is interpreted for each picture. In this manner, the video decoder 323 determines the number of bytes to jump to in the compressed A/V buffer 384 to find the start of the next compressed video picture. Other pertinent information in the picture level specification of each picture is also interpreted as necessary during video decoder 323 operations.

The media engine 322 can include other components not shown, as would be appreciated by one having ordinary skill in the art. For example, the media engine 322 can include a controller (not shown) that grants access to data transfers from system memory 349 to the display buffer 382 in a timely way that protects against the appearance of tear artifacts on the TV display 341. Another component of the media engine 322, preferably in the output system 348 of the media engine 322, is a digital encoder (DENC) (not shown). Data transfer is granted to locations in the display buffer 382 preferably corresponding to raster-scan ordered data already fed from the display buffer 382 into the DENC. In other words, data written to the display buffer 382 is preferably always behind (in raster-scan order) the display buffer locations read and fed into the DENC. Alternatively, data can be written to one or more secondary display buffers, often called off-screen buffers (not shown).

The DENC converts reconstructed picture data received at its input to an analog video signal that drives the TV display 341. The DENC receives data from media memory 324 in a manner that preferably results in a raster scan of displayed pixels consistent with the type of television connected to the DHCT 16. For an NTSC (National Television Standards Committee) display, the DENC receives 60 fields per second; each field belongs to one of two sets of alternating lines in each picture. According to the MPEG-2 standard's “Main Profile/Main Level,” the DENC can receive the equivalent of up to 30 pictures per second, each picture with a spatial resolution equal to 720×480 pixels, with each pixel requiring an average of 1.5 bytes.

In alternative implementations, either the video DENC or audio DAC (not shown), or both, may be “external to” the media engine 322. In other embodiments, there are multiple sets of video DENCs and audio DACs wherein each set is fed reconstructed digital media content corresponding to different MPEG-2 programs. Furthermore, any of the aforementioned functional components may either be located internal or external to the media engine 322.

The media engine 322 processes input data from media memory's display buffer 382 and picture buffer 386 according to information retained in the alpha-blend plane 388, and provides output data to the DENC. Data from the display buffer 382 and data from the picture buffer 386 are stored in a temporary repository memory (not shown) so that they may be readily provided to the input of an output switch (not shown) at the clocked pixel rate required for display. The temporary repository memory may be, for example, line buffers (not shown) or FIFOs (not shown) inside the media engine 322.

One or more programmed software applications are executed by utilizing the computing resources in the DHCT 16. Note that an application typically includes a client part and a server counterpart that cooperate to provide the complete functionality of the application. The applications may be resident in FLASH memory 351 or downloaded (or uploaded) into DRAM 352. Applications stored in FLASH memory 351 or DRAM 352 are executed by the processor 344 (e.g., a central processing unit or digital signal processor) under the auspices of the operating system 353. Data required as input by an application is stored in DRAM 352 or FLASH memory 351 and read by the processor 344 as need be during the course of application execution. Input data may be data stored in DRAM 352 by a secondary application or other source, either internal or external to the DHCT 16, or possibly anticipated by the application and thus created with the application at the time it was generated as a software application, in which case it is stored in FLASH memory 351. Data generated by an application is stored in DRAM 352 by the processor 344 during the course of application execution. DRAM 352 also includes application memory 370 that various applications may use for storing and/or retrieving data.

An application referred to as a navigator 355 is also resident in FLASH memory 351 for providing a navigation framework for services provided by the DHCT 16. The navigator 355 registers for and in some cases reserves certain user inputs related to navigational keys such as channel increment/decrement, last channel, favorite channel, etc. The navigator 355 also provides users with television related menu options that correspond to DHCT functions such as, for example, blocking a channel or a group of channels from being displayed in a channel menu presented on a screen display. In one embodiment, the navigator 355 receives an indication of a keypress on a remote control device 480 from the receiver 346, such as an indication that a trick mode button has been activated. The navigator 355 communicates this event to the operating system 353. Applications that have registered interest in such a keypress event are informed of the event. The PVR application 377 (in a customer premise based trick mode implementation) or the MOD application 363 (for network based trick mode implementations) are two applications that are informed for the respective implementations, which then triggers the advertisement insertion mechanisms of the preferred embodiments, as will be described below.

The FLASH memory 351 also contains a platform library 356. The platform library 356 is a collection of utilities useful to applications, such as a timer manager, a compression manager, a configuration manager, a hypertext markup language (HTML) parser, a database manager, a widget toolkit, a string manager, and other utilities (not shown). These utilities are accessed by applications via application programming interfaces (APIs) as necessary so that each application does not have to contain these utilities. Two components of the platform library 356 that are shown in FIG. 3 are a window manager 359 and a service application manager (SAM) client 357.

The window manager 359 provides a mechanism for implementing the sharing of the screen regions and user input. The window manager 359 in the DHCT 16 is responsible for, as directed by one or more applications, implementing the creation, display, and de-allocation of the limited DHCT screen resources. It allows multiple applications to share the screen by assigning ownership of screen regions, or windows. The window manager 359 communicates with the resource manager 367 to coordinate available resources (such as display memory) among different resource consuming processes. Such processes may be directly or indirectly invoked by one or more applications. For example, in the insertion of advertisements at the DHCT 16 in the same display as a presented media content instance, the window manager 359 is preferably involved to enable the sharing of screen resources.

The SAM client 357 is a client component of a client-server pair of components, with the server component (not shown) being located in the headend 11, preferably in the DNCS 223 (FIG. 2). A SAM database 360 (i.e., structured data such as a database or data structure) in DRAM 352 includes a data structure of services and a data structure of channels that are created and updated by the headend 11. Herein, database will refer to a database, structured data or other data structures as is well known to those of ordinary skill in the art. Applications can also be downloaded into DRAM 352 at the request of the SAM client 357, typically in response to a request by the user or in response to a message from the headend 11. In the example DHCT 16 illustrated in FIG. 3, DRAM 352 includes a media-on-demand (MOD) application 363, an e-mail application 365, a PVR application 377, and a web browser application 366. It should be clear to one with ordinary skill in the art that these applications are not limiting and merely serve as examples for embodiments of the invention. Furthermore, one or more DRAM based applications may be resident, as an alternative embodiment, in FLASH memory 351. These applications, and others provided by the subscriber television system operator, are top-level software entities on the network for providing services to the user.

An executable program or algorithm corresponding to an operating system (OS) component, or to a client platform component, or to an application, or to respective parts thereof, can reside in and execute out of DRAM 352 and/or FLASH memory 351. Likewise, data input into or output from any executable program can reside in DRAM 352 or FLASH memory 351. Furthermore, an executable program or algorithm corresponding to an operating system component, or to a client platform component, or to an application, or to respective parts thereof, can reside in FLASH memory 351, or in a local storage device (such as storage device 373) externally connected to or integrated into the DHCT 16 and be transferred into DRAM 352 for execution. Likewise, data input for an executable program can reside in FLASH memory 351 or a storage device and be transferred into DRAM 352 for use by an executable program or algorithm. In addition, data output by an executable program can be written into DRAM 352 by an executable program or algorithm and be transferred into FLASH memory 351 or into a storage device. In other embodiments, the executable code is not transferred, but instead, functionality is effected by other mechanisms.

The DHCT 16 can also include one or more wireless or wired interfaces, also called communication ports 374, for receiving and/or transmitting data to other devices.

The DHCT 16 can include at least one storage device 373 to provide storage for downloaded media content. In other embodiments, a storage device 373 can be omitted. The storage device 373 can be an optical storage device or a magnetic storage device, among others, and is preferably a hard disk drive. The storage device 373 comprises storage for media content that can be written to for storage and later read from for retrieval for presentation. The storage device 373 preferably includes at least one hard disk 300. Throughout this disclosure, references relating to writing to or reading from the storage device 373, or references regarding recordings from or to the storage device 373 will be understood to include read or write operations that are occurring to the actual medium (for example, the hard disk 300) of the storage device 373. The storage device 373 is also comprised of a controller 379 that preferably receives operating instructions from the device driver 311 of the operating system 353 and implements those instructions to cause read and/or write operations to the hard disk 300.

The storage device 373 is preferably internal to the DHCT 16, coupled to a common bus through a communication interface 375, preferably an integrated drive electronics (IDE) interface or small computer system interface (SCSI), although IEEE-1394 or USB can be used. In other embodiments, the storage device 373 can be externally connected to (and thus removable from) the DHCT 16 via the communication port 374 implemented as IEEE-1394 or USB or as a data interface port such as a SCSI or an IDE interface.

In one implementation, the processor 344, in communication generally with the device driver 311 and the storage device controller 379 and the signal processing system 314, effects retrieval of compressed video streams, compressed audio streams, and data streams corresponding to one or more media content instances from the storage device 373. Retrieved streams are deposited in an output cache in the storage device 373 and transferred to DRAM 352, and then processed for playback according to mechanisms well known to those having ordinary skill in the art. In some embodiments, one or more media content instances are retrieved and routed from the hard disk 300 to the media engine 322 for video and audio decoding simultaneously, and then further processed for eventual presentation on a display device or other device.

The PVR application 377 (included as an application for DHCTs that have a coupled storage device 373) provides for media content recording functionality by enabling the temporary writing to, and if requested, more permanent recording (i.e., relatively permanent) to the storage device 373. Downloaded media content that is received at each tuner of tuner system 345 is temporarily stored, or buffered, on the hard disk 300 of the storage device 373. The corresponding space on the hard disk 300 is called buffer space, or a time shift buffer (TSB) 378. Each tuner in tuner system 345 preferably has a respective TSB 378. Although one TSB 378 is shown, it will be understood that more TSBs can be used with multiple tuners. Note that buffering is understood to include temporarily storing media content, received from a local attached device (e.g., a camera, etc.) and/or either from reception of a broadcast digital channel or a digital compressed version of a broadcast analog channel, and/or data, in the buffer space, or TSB 378, of the storage device 373.

Under normal operation, the PVR application 377 effectively associates a temporary recording designation with the media content received into the TSB 378. The media content stored in the TSB 378 will either be deleted (i.e., the clusters storing the media content will be configured as writeable for eventual write operations that overwrite the media content within those clusters) or retained (through election by the user as one example) as a permanent recording. A permanent recording will be understood to include media content that is stored for an extended period of time, for example as decided by the user. The PVR application 377 maintains a data structure, or data record, for every downloaded media content instance. This data structure is preferably maintained on the hard disk 300 of the storage device 373, but can be maintained in memory 349 also.

The time shift buffer can be managed and implemented according to several mechanisms. Further information pertaining to creating and maintaining the TSB 378, as well as information pertaining to the processing of incoming digital and/or analog transmission signals, can be found in the applications entitled, “CONTROLLING SUBSTANTIALLY CONSTANT BUFFER CAPACITY FOR PERSONAL VIDEO RECORDING WITH CONSISTENT USER INTERFACE OF AVAILABLE DISK SPACE,” filed Dec. 6, 2001 under Ser. No. Oct. 10/010,270, and “DISK DRIVER CLUSTER MANAGEMENT OF TIME SHIFT BUFFER WITH FILE ALLOCATION TABLE STRUCTURE,” filed Dec. 5, 2001 under Ser. No. 10/005,628, both assigned to Scientific Atlanta, and both herein entirely incorporated by reference.

The PVR application 377 also includes functionality for presenting advertisements during trick mode displays for customer premise based trick mode implementations, in accordance with one embodiment of the invention. Preferably, the PVR application 377, in cooperation with other components (including the media engine 322 and the processor 344), includes functionality for detecting the activation of a trick mode and for retrieving advertisements stored in the storage device 373 (or memory 349) for presentation during the trick mode display. In one embodiment, the PVR application 377 can present an all-purpose type advertisement that is suitable (e.g., in terms of presentation recognition) to be used during any trick mode display. In other embodiments, described below, the PVR application 377 can utilize data decision processing to select the most suitable advertisement for presentation during the trick mode display. In either embodiment, trick mode activation, for example due to a user pressing one of the trick mode buttons on the remote control device 480, is preferably the triggering event to prompt the PVR application 377 to present the advertisement in the trick mode display. Further, trick mode activation via a user keypress event is also a triggering event to prompt the MOD application 363 to present an advertisement in the trick mode display according to mechanisms described below.

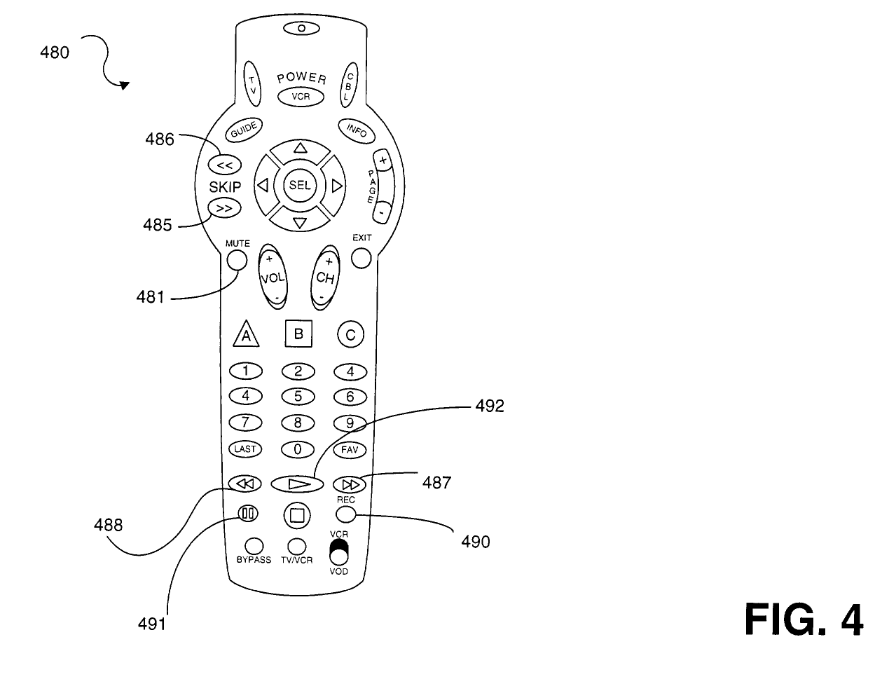

FIG. 4 is a schematic diagram of an example remote control device 480 for providing input to the DHCT 16, in accordance with one embodiment of the invention. The playback button 492 enables the playback of a media content instance. The mute button 481 can be used to discontinue audio during a presentation of a media content instance. The remote control device 480 also includes buttons to activate trick modes, including a pause button 491, a fast forward button 487, a rewind button 488, a skip ahead button 485, and a skip back button 486. Activation of these trick mode buttons results in one or more signals that are processed and interpreted to provide a trick mode display screen that will include video and/or audio advertisements, in accordance with one embodiment of the invention.

The pause button 491 enables the user to pause a media content instance, or pause during a search for a particular media content instance. The rewind button 488 enables the user to rewind through a recorded (e.g., buffered) media content instance, including rewinding at different speeds. The fast forward button 487 enables the user to fast forward through a particular recorded media content instance presentation at different speeds. The skip ahead button 485 provides for accelerated fast forward speeds (e.g., one keypress can skip 30 seconds of media content instance presentation), and the skip back button 486 likewise provides accelerated rewind speeds. Many alternative methods of providing user input may be used including a remote control device with different buttons, greater or fewer buttons, and or different button layouts, a keyboard device, a voice activated device, etc. The embodiments of the invention described herein are not limited by the type of device used to provide user input.

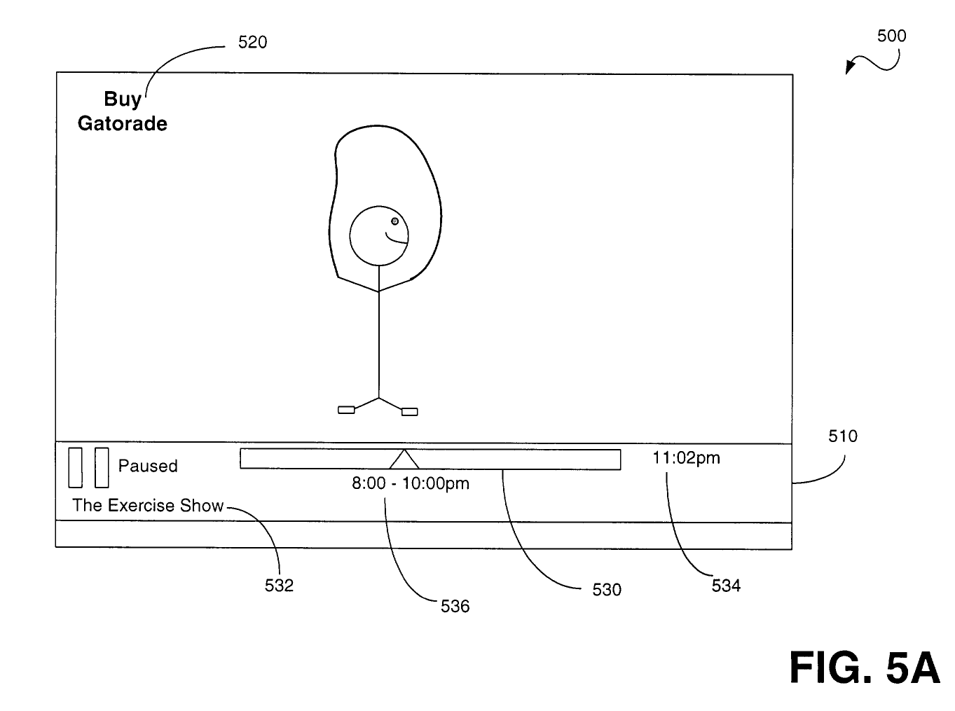

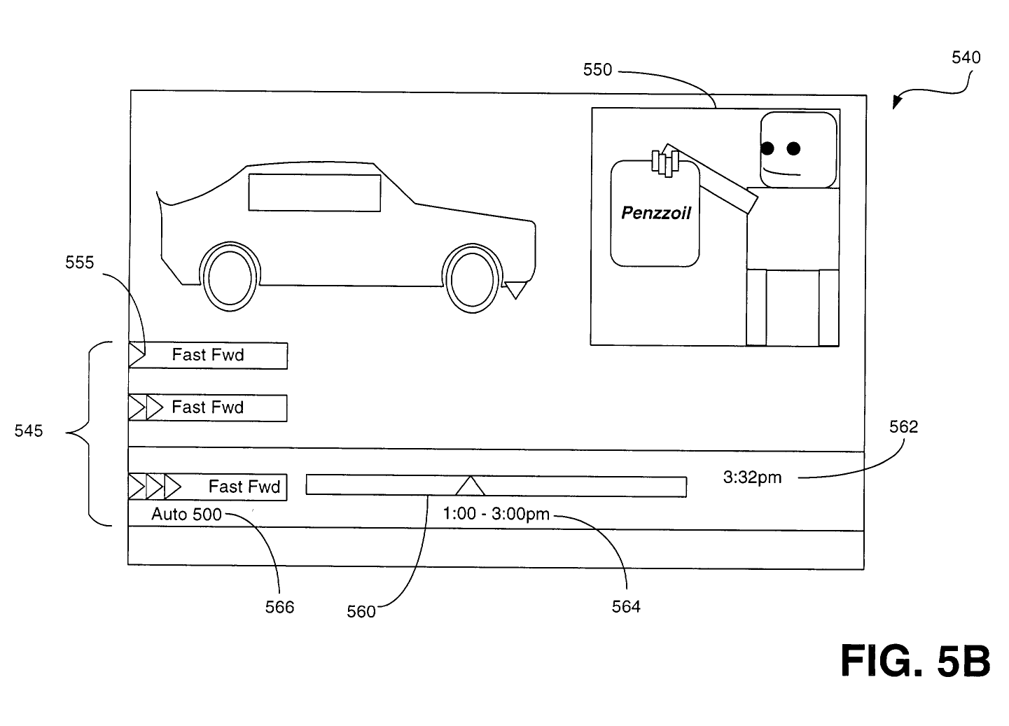

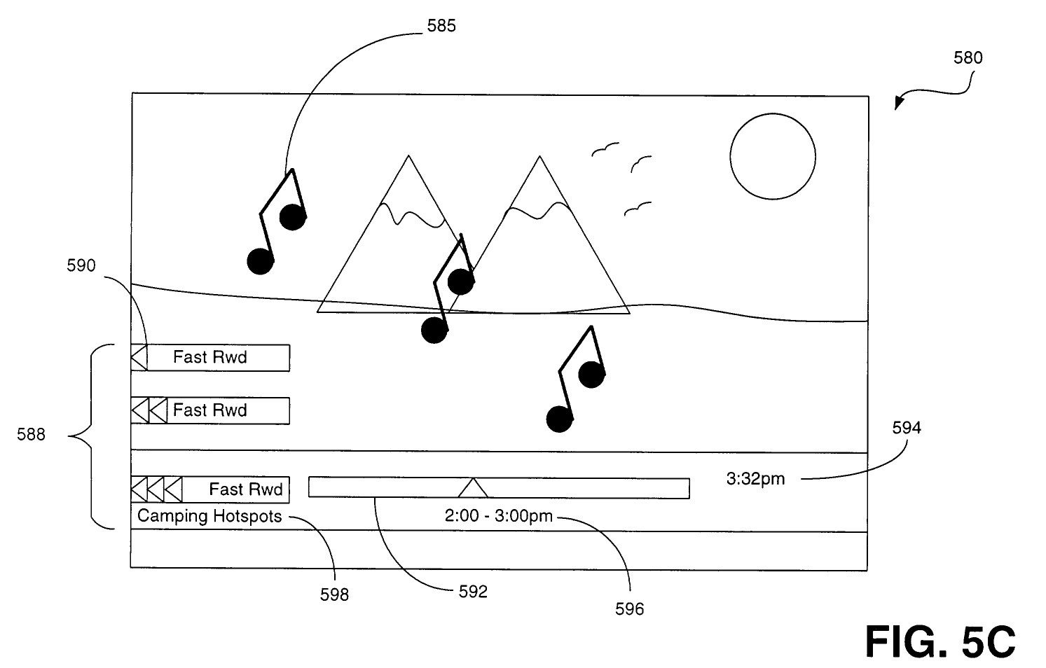

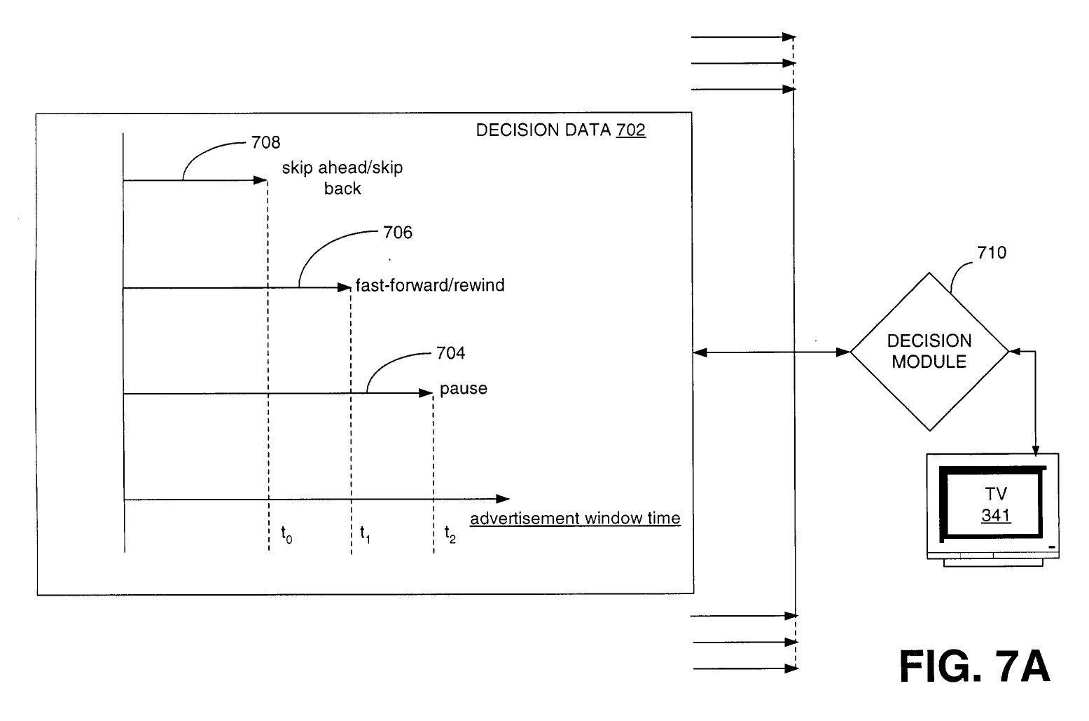

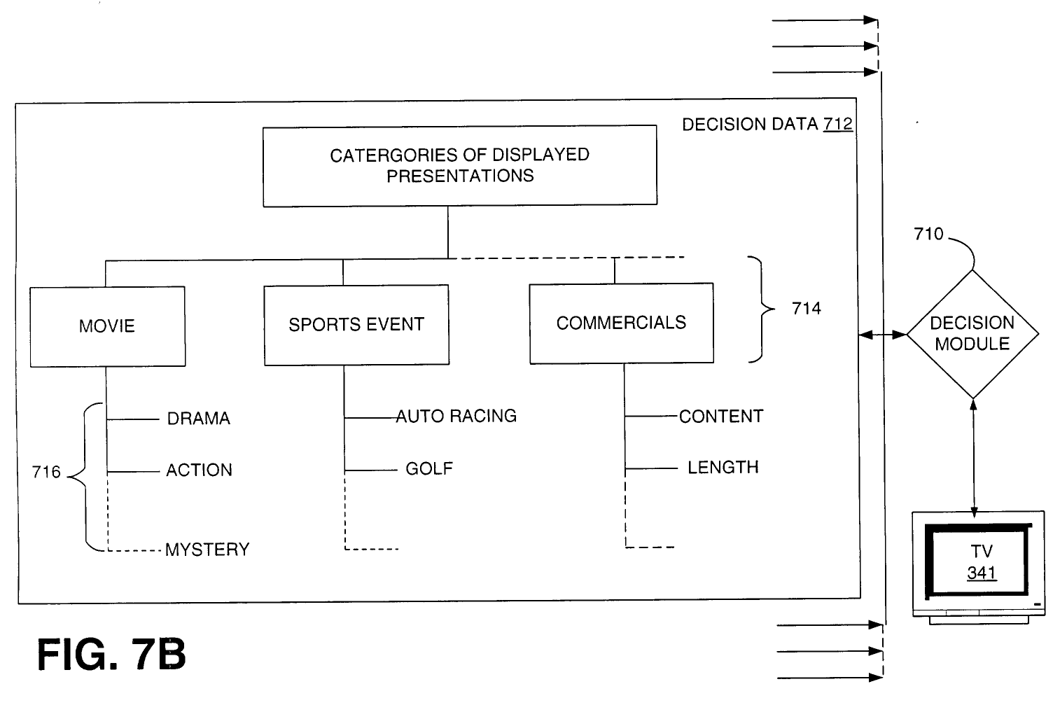

FIGS. 5A-5C are screen diagrams of example trick mode displays that include advertisements, in accordance with multiple embodiments of the invention. It will be understood that although three displays with three types of advertisements are shown, the examples are numerous of the types of displays and advertisements that can appear, and where they can appear, and in what type of format. Further, although described in association with progress bars and other elements of the screen displays, it will be understood that the screen displays can include other elements, or can omit elements, while still considered as being within the scope of the preferred embodiments of the invention. The advertisements described below and illustrated in FIGS. 5A-5C are triggered by the activation of trick modes. The determination of the type of advertisement to present and how to present it can be based on decision data in some embodiments as is described below in association with FIGS. 7A-7B, or in other embodiments, can be presented in a rote manner.

The trick mode displays can be generated in a variety of ways, as would be appreciated by one having ordinary skill in the art. In some implementations, such as in MPEG compression, the trick mode displays can be generated by retrieving a series of intracoded (I) frames of the presented media content instance from the storage device 373 (FIG. 3) of the DHCT 16 (FIG. 3) and presenting one or more I frames to the TV 341 (FIG. 3). In other embodiments, for example for fast forward modes, all frames can be used for presentation on the TV 341. The advertisements can be inserted as an overlay in these implementations, among others.

FIG. 5A is a screen diagram of an example pause mode display 500 resulting from a user pressing the pause button 491 (FIG. 4) on the remote control device 480 (FIG. 4). The example pause mode display 500 includes a pause banner 510 overlaid on a media content instance presentation, for example, The Exercise Show. The display 500 also includes a textual advertisement 520 that presents to the user the message, “Drink Gatorade”. This advertisement can be presented based on decision data (as described below), input to the preferred embodiments of the invention, that provides the category of the show (e.g., exercise), which due to this decision data, presents an exercise related advertisement. The pause banner 510 includes a progress bar 530 to provide the user visual feedback as to the position of the user in the presentation with respect to the end of the presentation. Further information on progress bars and the mechanisms for generating them can be found in the patent application entitled, “PROGRAM POSITION USER INTERFACE FOR PERSONAL VIDEO RECORDING TIME SHIFT BUFFER,” filed Dec. 20, 2001 under Ser. No. 10/034,028, assigned to Scientific-Atlanta, and herein entirely incorporated by reference.

The pause banner also includes the title 532 of the media content instance, the current time 534, and the scheduled presentation time 536. The advertisement 520 is presented in response to receiving an indication that a trick mode has been activated. There are many varieties of textual advertisements, including providing subliminal advertisements, translucent advertisements, static frames, moving frames, messages on a banner, messages below a banner, and/or even by presenting links to web-based content, among others.

FIG. 5B is a screen diagram of an example fast forward display screen 540 that includes a fast forward banner 545 and an advertisement 550 presented in a picture in picture format overlaid on the presentation of a racing event. In this embodiment, a video picture in picture advertisement 550 is presented that is related to (although it does not have to be) the presented event. Here, an auto spokesperson is making a pitch for Pennzoil oil during the presentation of the auto sports event entitled the “Auto 500”. The fast forward banner 545 includes symbols 555 associated with the different speeds of fast forwarding, which suggest actions a user can take to advance through the media content instance presentation. Also included within the fast forward banner 545 is a progress bar 560, the current time 562, the scheduled presentation time 564, and the title of the event 566. Some example display formats include quarter screen, full screen, among others. The advertisement displayed can take the form of video, static frame, among others.

FIG. 5C is a screen diagram of an example rewind display screen 580 that is similarly structured to the fast forward display screen 540. As shown, the rewind display screen 580 includes an audio advertisement (as denoted by the musical note symbols 585, though some embodiments may include no visual indications) presented during the rewinding through a presentation of Camping Hotspots. The rewind banner 588 includes the different rewinding speed symbols 590 and the progress bar 592, which includes the current time 594, the scheduled presentation time 596, and the title 598. Examples of some audio presentations for the trick mode display include jingles, radio-type ads, including spoken audio tracks, among others.

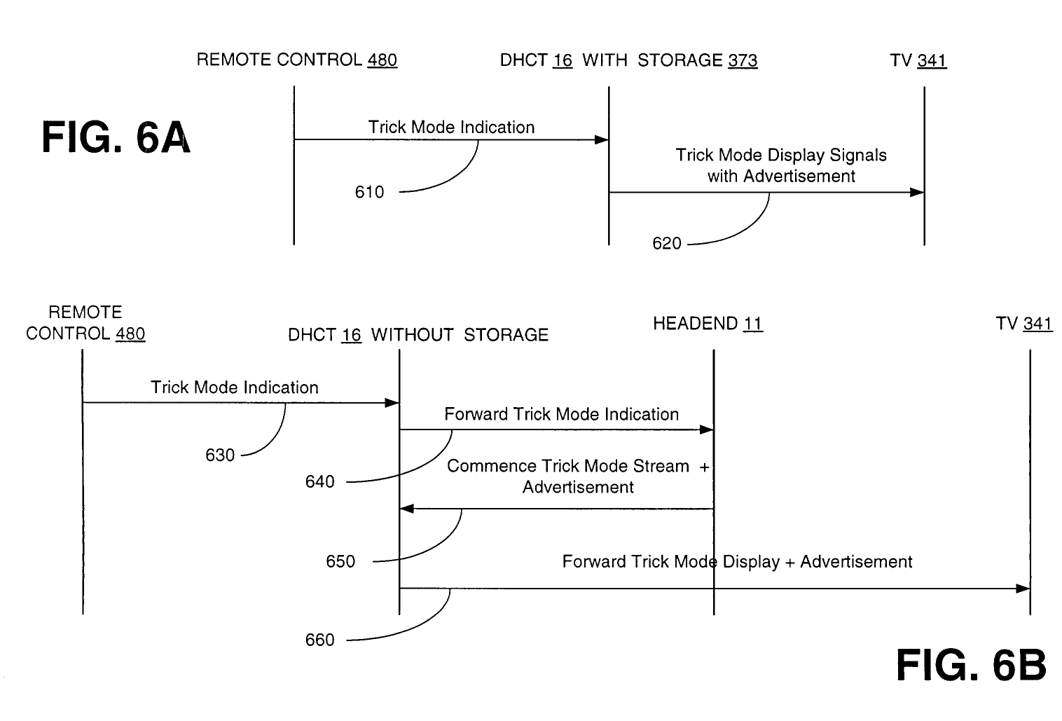

The systems and methods for presenting advertising during trick mode displays, in accordance with the preferred embodiments of the invention, can occur in network based trick mode implementations and customer premise trick mode implementations. FIGS. 6A-6B present timing diagrams for some example trick mode advertisement insertion mechanisms, in accordance with several embodiments of the invention. FIG. 6A shows one example trick mode advertisement insertion mechanism in a customer based trick mode implementation, in accordance with one embodiment of the invention. The components of this example mechanism generally include a remote control device 480, a DHCT 16 that includes a storage device 373, and a TV 341. As shown, the trick mode is preferably activated from a remote control device 480, such as by a user pressing one of the trick mode buttons while watching a displayed media content instance presentation.

In response to the user keypress (of a trick mode button), an indication of this keypress is sent to the DHCT 16 (step 610). The PVR application 377, in cooperation with the navigator 355 (FIG. 3), detects the trick mode and retrieves the advertisement data from the storage device 373 (FIG. 3). Note that the headend 11 (FIG. 2) preferably delivers the media content instance and advertisement data to the DHCT 16, with the advertisement data preferably delivered ahead of time and updated regularly (e.g., every 1-2 days), in a somewhat similar manner to the way IPG data is delivered and updated. After the trick mode indication is received at the DHCT 16 (or prior to the indication in anticipation, during a particular media content instance, of suitable advertisements), the PVR application 377 effects the routing of the advertisement data to memory 349, and then directs the media engine 322 (FIG. 3) to use that data to generate the graphical and/or textual advertisement overlay, as described above. Then, the advertisement is inserted into the video and/or audio stream that comprises the trick mode display for presentation to the TV 341 (step 620).

Another example trick mode advertisement insertion mechanism in a customer premise based trick mode implementation (not shown) includes providing trick mode functionality and advertisement storage at separate subscriber television system locations. For example, the trick mode functionality can be implemented at the headend 11 (FIG. 2), and the advertisement data can be stored at the DHCT 16 (FIG. 3) in the storage device 373 (FIG. 3). Upon the activation of a trick mode, the headend 11 can provide the resultant trick mode functionality and the DHCT 16 can insert the advertisements. In other implementations, the headend 11 can provide the advertisements and the DHCT 16 provides the trick mode functionality based on internal PVR mechanisms. If the queuing of the advertisement data is too much of a burden at the headend 11, the advertisement data can be pre-loaded to the DHCT 16 at pre-defined intervals. The preferred embodiments of the invention can determine the type of advertisement to use and the manner of presenting it (e.g., translucent display, quarter screen, video, audio, etc.), or in other embodiments, the data stream can include embedded directions as to the proper advertisement to use and the manner of using it.

Another customer premise based trick mode application can include implementations where the PVR application 377 (FIG. 3) can display one or more I-frames retrieved from the media content instance video signal. For example, an automobile commercial can start with an I frame that depicts the car in a stylish setting. The viewer can fast forward over this, but the I frame remains, picture in picture, for the duration of the trick mode.

FIG. 6B is a timing diagram of an example trick mode advertisement insertion mechanism in a network based trick mode implementation, in accordance with one embodiment of the invention. For example, in one network based trick mode implementation, the headend 11 (FIG. 2) can be the source of the trick mode displays and the advertisements, with the DHCT 16 (FIG. 3) serving the function as an interface between the headend 11 and the television 341 (FIG. 3), and as an interface between a user and the television 341. Such implementations can arise when the DHCT 16 does not include coupled persistent storage (e.g., storage device 373, FIG. 3) and/or insufficient memory, although such implementations can also be used with DHCTs having coupled storage and/or sufficient memory. In another implementation, the headend 11 can provide for the trick mode functionality but not advertisement storage, or vice versa in other implementations.

As shown, step 630 includes the remote control device 480, in response to a user keypress event, sending a trick mode indication to the DHCT 16. The DHCT 16 (i.e., the MOD application 363 (FIG. 3) of the DHCT) forwards this indication to the headend 11 where it is acknowledged and acted upon by the MOD application server 219 (FIG. 2). The MOD application server 219 halts the data stream (i.e., directs the video pump 221 (FIG. 2) to stop sending the data stream) from which the media content instance that the user was watching (pre-keypress) is being delivered. The headend 11 then sends the trick mode stream with the advertisement (step 650) preferably under the same MPEG program number as the trick mode audio and video. In one embodiment, the advertisement can be an overlay that is stored at the video pump 211 as part of the trick mode video (i.e., as part of the video or audio PID). In another embodiment, the advertisement can be carried under a separate PID in addition to the video and/or audio PID of the trick mode stream. Still in other embodiments, the advertising can be carried on a separate PID of the non-trick mode stream (the signal carrying the presented media content prior to activation of a trick mode). In this latter embodiment, the DHCT 16 can temporarily store the advertisement (e.g., in DRAM 352) and then present the advertising while the video pump 211 is switching to the trick mode stream.

Note that selection of the advertisements can occur according to many different mechanisms, according to the preferred embodiments of the invention. The advertisement can be encoded and stored with the trick mode video on the pump 211 (FIG. 2), thus inferring that the advertisement selection is made when the video is encoded, which preferably involves coordination with the content manager 221 (FIG. 2). The advertisement can also be selected by the MOD application 363 (FIG. 3) and/or the PVR application 377 (FIG. 3), selecting from advertisements recently acquired and stored at the DHCT 16 (FIG. 3). The advertisement can be selected by the MOD server 319 (FIG. 2), which can direct the pump 211 to deliver advertisement material simultaneously with the non-trick mode media content. In such a case, the DHCT 16 can use whatever advertisement it finds in the transport stream if the viewer invokes a trick mode. In some implementations, the MOD server 319 can select the advertisement and deliver it when the user invokes a trick mode.

Step 660 includes the DHCT 16 forwarding the advertisement along with the video and/or audio signal comprising the trick mode display for presentation to the TV 341.

Another embodiment (not shown) includes an implementation where a second PID can be used to carry alternate forms of an advertisement (for example, high speed versions for implementations using a skip ahead or skip back trick mode) simultaneously with a normal speed (e.g., 30 seconds) version of the advertisement. For example, the second PID might ordinarily be empty (no content) except when a sponsor has paid for an enhanced advertisement mechanism wherein both a 30-second commercial and a 5-second “high-speed friendly” commercial version is provided. Then, when fast forwarding through the normal speed commercial, the user witnesses rapidly changing scenes. When the special advertisement is reached, the 5-second version of the commercial is shown instead of the 30-second version with the rapidly changing scenes. After this 5-second commercial insertion, fast forward returns to rapidly changing scenes. If the trick mode is exited before 5 seconds has elapsed, the user will be presented with the original commercial (i.e., the 30-second commercial). Thus, in this embodiment, the advertisement replaces the normal audio and video stream entirely. The advertisement is not presented as an overlay, quarter screen or otherwise sharing the screen with the original media content instance included in all or part of the screen. For example, instead of a normal speed commercial with the auto spokesperson with accompanying sound and car scenes that blurs by a user during a trick mode, the viewer can see an abbreviated version in normal speed, a still frame version for the 5 second span, or an entirely different sequence of scenes.

FIGS. 7A-7B are block diagrams of example decision data that can be used by the preferred embodiments of the invention to make a determination as to the type of advertisement to insert into the trick mode display, and the manner of presenting it. The decision data includes media content information retrieved from the data stream and trick mode performance information preferably programmed into the DHCT 16 (FIG. 3) and/or the headend 11 (FIG. 2). The decision data can be included among other inputs to a decision module (not shown). The decision module, in customer premise based trick mode implementations, can be integrated into the PVR application 377 or other applications, or as a separate module. In network based trick mode applications, the decision module can be integrated into the MOD server 319 (FIG. 2) or other servers in the headend 11, such as the content manager 221 (FIG. 2). The decision module represents example decision processing functionality according to one embodiment of the invention. The decision module can include a look-up table or database (i.e., structured data such as a database or data structure), and the decision module can be located at the headend 11 and/or at the DHCT 16 (FIG. 3).

In one embodiment, the decision data can be input into the look up table structure (not shown) of the decision module, which, under processor and application control, matches the decision data with a set of rules (for example “if-then” rules or inference or other artificial intelligence type rules, among others) for presenting an appropriate advertisement during the trick mode display. The rules can be based in part on user behavior and viewing habits, as one example. For example, if the user selects the pause button 491 (FIG. 4), surveys and/or statistical behavior incorporated into the rules may indicate that a user typically hits pause to get up to go to the kitchen for a drink, or to answer the phone. Thus, in response to the activation of the pause mode, the pause signal indication can be presented to the look-up table. The trick mode information maintained in the look up table can be used to indicate the time window available during a pause mode. Based on this available time window, and based on behavioral rules, an advertisement can be presented that is suitable for such user behavior and can be presented in a time duration based on the trick mode information gleaned from the look-up table. One example advertisement that can be presented is a radio-type advertisement or song of a defined duration, since either can be heard while the user is away from the TV. One or more of the decision data can be used to determine which advertisement to insert in the trick mode display and how to present the advertisement. In other embodiments, an advertisement can be presented during the trick mode display without the processing of decision data.

FIG. 7A is a schematic diagram of example decision data that can be considered when deciding which advertisement to use and how to present it, in accordance with one embodiment of the invention. As shown, the example decision data is represented as a decision data block 702, which includes a relationship between the particular trick mode activated and the corresponding time window during which the advertisement can be inserted for the estimated duration of the trick mode display. The time references t₀ through t₂ can represent average time elapsed per commercial that a user is attempting to bypass with the trick mode functionality, as one example among many. The trick mode systems at the headend 11 (FIG. 2) and the DHCT 16 (FIG. 3) include the clock and timing mechanisms (not shown) and the media content information to recognize media content instance durations (and start and end times). The preferred embodiments of the invention can use this information and infrastructure, along with other decision data to help make decisions as to what types of advertisements to insert during the trick mode display.

The decision data block 702 can be one factor used as input to the decision module described above, represented here as decision module 710, to present an advertisement, in addition to other input data as represented by the added lines input into the decision module 710, which based on the evaluation of the data chooses an advertisement for presentation at the TV 341. As shown, the trick modes include the pause function, the fast forward and rewind function (at different speeds, although one is shown), and the skip ahead and skip back function. The pause advertisement window duration 704 provides the longest duration of advertisement window time, and thus longer playing advertisement insertions can be used.

Certain functions can be provided to the user to offset incorrect estimation of the advertisement duration, such as, for example, a mute button 481 on the remote control device 480 (FIG. 4) to turn off the volume, or a clear button (not shown) if the advertisement is displayed on the trick mode display in too obtrusive of a manner. The fast forward/rewind ad window duration 706 provides the second longest advertisement window time for consideration, followed by the skip ahead/skip back ad window duration 708, which has the shortest advertisement window duration. For example, a trick mode display, resulting from a user pressing the skip ahead button 485 (FIG. 4) (or skip back button 486 (FIG. 4)), may cause the rules to present subliminal, or very short-lived, advertising due to the brevity of time available for advertising.

In other embodiments, the advertisements can be all-purpose type advertisements that can be implemented in substantially all circumstances in which an advertisement can be inserted, regardless of the trick mode activated. For example, an advertisement can be developed that is short enough in duration and unobtrusive enough to be presented in either of the trick mode displays with a relatively high percentage of viewer approval.

At the completion of the trick mode (e.g., when the user presses the “PLAY” button to resume normal viewing), in some implementations, there can be some overlap of the trick mode advertisement with the movie or program episode that the user is viewing. In one embodiment, the completion of the trick mode can be detected and the advertisement can be cut short. Other embodiments can take advantage of the short latency that typically exists between the user action of ending the trick mode and the resumption of normal viewing. Some trick mode systems recover from this latency by programming in the latency (e.g., backing up the display automatically a defined period of time). For example, after receiving the keypress indication to cease a trick mode, a decoder (e.g., video decoder 323 (FIG. 3) for the customer premise based trick mode implementation) recovers additional frames to account for an average expected reaction time between user observation and the keypress event. But even in these implementations, the recovery might not be to the satisfaction of the viewer based on the reaction time of the user, thus prompting further user action (keypresses) to be positioned acceptably in the presentation. Thus, it is expected that there may be some extra time inherent in the process that allows a particular advertisement to be faded out in some embodiments as opposed to being cut short.

FIG. 7B is a block diagram of other example decision data, in accordance with one embodiment of the invention. The decision data, represented as decision data block 712, can be provided to the decision module 710, among other inputs, which after evaluation, determines the advertisement for presentation at the TV 341. The decision data block 712 includes categories 714 of displayed presentations. In one embodiment, the type of advertisement to insert can be determined based, in whole or in part, on the category 714 of the media content instance presentation currently presented in the trick mode display. The categories 714 can include movies, sports events, special events, news, and/or commercials, among others. These categories 714 can include another layer of categories, or subcategories 716, which can be further refined. For example, subcategories for the movie category 714 can include drama, action, comedy, and mystery, among others. The category and subcategory information (typically included as metadata (i.e., data about data)) can be provided, for example, in the data stream sent from the headend 11 (FIG. 2) and stored in the storage device 373 (FIG. 3) or memory 349 (FIG. 3) when the decision processing of the preferred embodiments are implemented at the DHCT 16 (FIG. 3), or maintained at the headed 11 when the processing is included at the headend 11.

As one example among many, the trick mode display can be of a presentation that has a category 714 of sports events, and a subcategory of auto racing 716. Thus, in response to the trick mode activation and the evaluation of the decision data block 712, the resulting advertisement inserted into the trick mode display and presented to the user is a static overlay picture of a Pennzoil oil can. As another example, if the category 714 includes a commercial, possible subcategories 716 for consideration include the content, the length, and the nature of the advertisement presentation (e.g., low action, high action, animated, etc.), among others. For example, one consideration that can be weighed heavily in decision processing at the decision module 710 is that if the commercial is for Brand X, then an advertisement on a static overlay in big bold letters conveying the trademark of Brand X can be presented. In other embodiments, as indicated above, the category of presented media content can be ignored, or not weighted so heavily in the determination of the advertisement to insert.

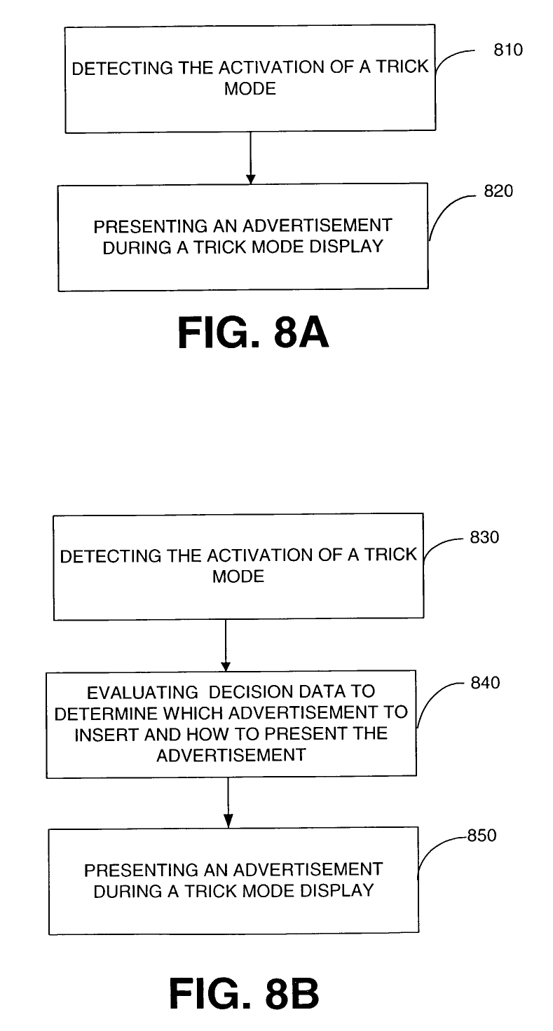

FIGS. 8A-8B are flow diagrams of some example methods of the preferred embodiments for presenting advertisements during trick mode displays. FIG. 8A is a “no-nonsense approach” that detects the trick mode, and presents an all-purpose advertisement that can be used in most circumstances. FIG. 8B includes the steps illustrated in FIG. 8A, with an additional step for the evaluation of decision data. The blocks in the flow diagrams of FIGS. 8A-8B should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

FIG. 8A illustrates one method of the preferred embodiments for presenting advertisements during a trick mode display. Step 810 includes the step of detecting the activation of a trick mode. With reference to FIG. 4, and as described above, the triggering event is preferably a user selecting a trick mode button, such as the pause button 491, the fast forward button 487, the rewind button 488, the skip ahead button 485, or the skip back button 486. This detection will preferably occur at the DHCT 16 for customer premise based trick mode functionality, or at the headend 11 (e.g., at the MOD server 219 (FIG. 2) in cooperation with the MOD application 363 (FIG. 3)) for network based trick mode functionality. Step 820 includes the step of presenting an advertisement during a trick mode display. The presentation can take the form of an audio advertisement, such as a jingle or song, or other audio content, or the advertisement can be presented visually, or as a combination of the two. Two example mechanisms employed to insert the advertisement for delivery to the television 341 (FIG. 3) include inserting it in the data stream at the video pump 211 (FIG. 2) at the headend 11, or by inserting it at the media engine 322 (FIG. 3) at the DHCT 16 (FIG. 3).

FIG. 8B is a screen diagram of one example method of the preferred embodiments for presenting advertisements in a trick mode display. Step 830 includes detecting the activation of a trick mode, as described above. Step 840 includes the step of evaluating decision data to determine the advertisement to use and how to present the advertisement. Step 850 includes presenting an advertisement during a trick mode display.

Other embodiments are contemplated for sending advertisements to the DHCT 16 (FIG. 3), including sending the advertisement in the vertical blanking interval (VBI) of the analog video signal, as one example among many.

The PVR application 377, MOD application 363, and the MOD server 219 can be implemented in hardware, software, firmware, or a combination thereof. In the preferred embodiment(s), the PVR application 377, MOD application 363, and the MOD server 219 is implemented in software or firmware that is stored in a memory and that is executed by a suitable instruction execution system. If implemented in hardware, as in an alternative embodiment, the PVR application 377, MOD application 363, and the MOD server 219 may be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The PVR application 377, MOD application 363, and the MOD server 219, which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable readonly memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

It should be emphasized that the above-described embodiments of the present invention, particularly, any “preferred embodiments” are merely possible examples of implementations, merely setting forth a clear understanding of the principles of the inventions. Many variations and modifications may be made to the above-described embodiments of the invention without departing substantially from the spirit of the principles of the invention. All such modifications and variations are intended to be included herein within the scope of the disclosure and present invention and protected by the following claims.

Therefore, having thus described the invention, at least the following is claimed:

1. A method for presenting advertisements to a user during video presentations, the method comprising the steps of:
detecting a trick mode activation during a media content instance presentation; and
responsive to the trick mode activation, presenting an advertisement during a trick mode display of the media content instance presentation.

2. The method of claim 1, wherein the step of detecting includes receiving an indication of a trick mode button keypress, wherein the trick mode button is on a remote control device.

3. The method of claim 1, wherein the trick mode activated includes the functions of fast forward, rewind, pause, skip ahead, and skip back.

4. The method of claim 1, further including the step of inserting an advertisement in a video signal that is included in the trick mode display.

5. The method of claim 4, wherein the trick mode display includes at least one of a fast forwarding video presentation, a paused video presentation, a rewinding video presentation, a video presentation that is skipping ahead, and a video presentation that is skipping back.

6. The method of claim 4, wherein the advertisement includes at least one of a video advertisement, an audio advertisement, at least one still frame, moving frames, a textual advertisement, a graphical advertisement, a translucent advertisement, and a subliminal advertisement.

7. The method of claim 1, further including the step of inserting an audio advertisement in an audio signal that is included in the trick mode display, wherein the audio advertisement includes at least one of a song, a spoken audio track, and a jingle.

8. The method of claim 1, further including the steps of inserting an audio advertisement in an audio signal that is included in the trick mode display and inserting the visual advertisement in a visual signal that is included in the trick mode display.

9. The method of claim 1, further including the step of determining the type of advertisement to present and how to present the advertisement.

10. The method of claim 9, wherein the steps of determining includes the steps of determining the trick mode activated, determining the characteristics of the media content that is presented in the trick mode display, and selecting an advertisement that has a duration that allows for recognition of the advertisement to the user during the trick mode display and that is related to the characteristics of the media content instance.

11. The method of claim 1, further including the step of inserting at a media client device the advertisement in a decoded video stream.

12. The method of claim 1, further including the step of inserting the advertisement in a compressed video stream at a server device located remotely from a media client device.

13. The method of claim 12, wherein the step of inserting the advertisement in a compressed video stream includes the step of including the advertisement as data in at least one of a video PID and an audio PID having a same MPEG program number in a trick mode stream.

14. The method of claim 12, wherein the step of inserting the advertisement in a compressed video stream includes the step of including the advertisement as data in a PID that is separate from but of a same MPEG program number as that of at least one of a video PID and an audio PID in a trick mode stream.

15. The method of claim 14, wherein the advertisement data in the separate PID is used to generate an advertisement that replaces the video and audio signal of the trick mode display.

16. The method of claim 12, wherein the step of inserting the advertisement in a compressed video stream includes the step of including the advertisement as data in a PID that is associated with the MPEG program number of a non-trick mode stream.

17. The method of claim 1, further including the step of inserting the advertisement in a vertical blanking interval of an analog signal.

18. The method of claim 1, further including the step of storing the advertisements at a media client device.

19. The method of claim 1, further including the step of storing the advertisements at a server device remote from a media client device.

20. The method of claim 1, wherein the step of presenting includes presenting the advertisement as an overlay of the trick mode display.

21. A method for presenting advertisements to a user during video presentations, the method comprising the steps of:
detecting a trick mode button keypress indication during a media content instance presentation, the trick mode button keypress causing a trick mode display of the media content instance presentation;
responsive to the trick mode activation, retrieving an advertisement from a storage device;
inserting the advertisement in a video signal that is included in the trick mode display; and
presenting the advertisement in the trick mode display.

22. The method of claim 21, further including the step of inserting an advertisement in an audio signal that is included in the trick mode display, wherein the audio advertisement includes at least one of a song, a spoken audio track, and a jingle.

23. The method of claim 21, wherein the trick mode activated includes the functions of fast forward, rewind, pause, skip ahead, and skip back.

24. The method of claim 21, wherein the trick mode button includes at least one of a fast forward button, rewind button, pause button, skip ahead button, and skip back button.

25. The method of claim 21, wherein the trick mode display includes at least one of a fast forwarding video presentation, a paused video presentation, a rewinding video presentation, a video presentation that is skipping ahead, and a video presentation that is skipping back.

26. The method of claim 21, wherein the advertisement includes at least one of a video advertisement, an audio advertisement, at least one still frame, moving frames, a textual advertisement, a graphical advertisement, a translucent advertisement, and a subliminal advertisement.

27. The method of claim 21, further including the steps of inserting an audio advertisement in an audio signal that is included in the trick mode display and inserting the visual advertisement in a video signal that is included in the trick mode display.

28. The method of claim 21, further including the step of determining the type of advertisement to present and how to present the advertisement.

29. The method of claim 28, wherein the steps of determining includes the steps of determining the trick mode activated, determining the characteristics of the media content that is presented in the trick mode display, and selecting an advertisement that has a duration that allows for recognition of the advertisement to the user during the trick mode display and that is related to the characteristics of the media content instance.

30. The method of claim 21, wherein the step of inserting includes presenting the advertisement as an overlay of the trick mode display.

31. A method for presenting advertisements to a user during video presentations, the method comprising the steps of:
detecting a trick mode button keypress indication during a media content instance presentation, the trick mode button keypress causing a trick mode display, wherein the trick mode button includes at least one of a fast forward button, rewind button, pause button, skip ahead button, and skip back button;
responsive to the trick mode activation, retrieving an advertisement from a storage device, wherein the storage device is located in at least one of a media client device and a server device located remotely from the media client device;
inserting the advertisement in a video signal that is included in the trick mode display of the media content instance presentation, wherein the trick mode, display includes at least one of a fast forwarding video presentation, a paused video presentation, a rewinding video presentation, a video presentation that is skipping ahead, and a video presentation that is skipping back;
inserting an audio advertisement in an audio signal that is included in the trick mode display of the media content instance presentation; and
presenting the advertisement in the trick mode display of the media content instance presentation.

32. A system for presenting advertisements to a user during video presentations, the system comprising:
a memory with logic; and
a processor configured with the logic to detect a trick mode activation during a media content instance presentation, wherein the processor is further configured with the logic to present an advertisement during a trick mode display of the media content instance presentation in response to the trick mode activation.

33. The system of claim 32, wherein the processor is further configured with the logic to receive an indication of a trick mode button keypress, wherein the trick mode button is on a remote control device.

34. The system of claim 32, wherein the trick mode activated includes the functions of fast forward, rewind, pause, skip ahead, and skip back.

35. The system of claim 32, wherein the processor is further configured with the logic to insert an advertisement in a video signal that is included in the trick mode display.

36. The system of claim 32, wherein the trick mode display includes at least one of a fast forwarding video presentation, a paused video presentation, a rewinding video presentation, a video presentation that is skipping ahead, and a video presentation that is skipping back.

37. The system of claim 32, wherein the advertisement includes at least one of a video advertisement, an audio advertisement, at least one still frame, moving frames, a textual advertisement, a graphical advertisement, a translucent advertisement, and a subliminal advertisement.

38. The system of claim 32, wherein the processor is further configured with the logic to insert an audio advertisement in the audio signal that is included in the trick mode display, wherein the audio advertisement includes at least one of a song, a spoken audio track, and a jingle.

39. The system of claim 32, wherein the processor is further configured with the logic to insert an audio advertisement in an audio signal that is included in the trick mode display and insert a visual advertisement in the video signal that is included in the trick mode display.

40. The system of claim 32, wherein the processor is further configured with the logic to determine the type of advertisement to present and how to present the advertisement.

41. The system of claim 40, wherein the processor is further configured with the logic to determine the trick mode activated, determine the characteristics of the media content that is presented in the trick mode display, and select an advertisement that has a duration that allows for recognition of the advertisement to the user during the trick mode display and that is related to the characteristics of the media content instance.

42. The system of claim 32, wherein the processor is further configured with the logic to insert at a media client device the advertisement in a decoded video stream.

43. The system of claim 32, wherein the processor is further configured with the logic to insert the advertisement in a compressed video stream at a server device located remotely from a media client device.

44. The system of claim 43, wherein the processor is further configured with the logic to include the advertisement as data in a at least one of a video PID and an audio PID having a same MPEG program number in a trick mode stream.

45. The system of claim 43, wherein the processor is further configured with the logic to include the advertisement as data in a PID that is separate from but of a same MPEG program number as that of at least one of a video PID and an audio PID in a trick mode stream.

46. The system of claim 45, wherein the processor is further configured with the logic to generate an advertisement that replaces the video and audio signal of the trick mode display.

47. The system of claim 43, wherein the processor is further configured with the logic to include the advertisement as data in a PID that is associated with the MPEG program number of a non-trick mode stream.

48. The system of claim 32, wherein the processor is further configured with the logic to insert the advertisement in a vertical blanking interval of an analog signal.

49. The system of claim 32, wherein the processor is further configured with the logic to store the advertisements at a media client device.

50. The system of claim 32, wherein the processor is further configured with the logic to store the advertisements at a server device remote from a media client device.

51. The system of claim 32, wherein the processor is further configured with the logic to present the advertisement in the trick mode display as an overlay.

52. A system for presenting advertisements to a user during video presentations, the system comprising:
a memory with logic; and
a processor configured with the logic to detect a trick mode button keypress indication during a media content instance presentation, the trick mode button keypress causing a trick mode display of the media content instance presentation, wherein the processor is further configured with the logic to retrieve an advertisement from a storage device in response to the trick mode activation, wherein the processor is further configured with the logic to insert the advertisement in a video signal that is included in the trick mode display, wherein the processor is further configured with the logic to present the advertisement in the trick mode display.

53. The system of claim 52, wherein the processor is further configured with the logic to insert an advertisement in an audio signal that is included in the trick mode display, wherein the audio advertisement includes at least one of a song, a spoken audio track, and a jingle.

54. The system of claim 52, wherein the trick mode activated includes the functions of fast forward, rewind, pause, skip ahead, and skip back.

55. The system of claim 52, wherein the trick mode button includes at least one of a fast forward button, rewind button, pause button, skip ahead button, and skip back button.

56. The system of claim 52, wherein the trick mode display includes at least one of a fast forwarding video presentation, a paused video presentation, a rewinding video presentation, a video presentation that is skipping ahead, and a video presentation that is skipping back.

57. The system of claim 52, wherein the advertisement includes at least one of a video advertisement, an audio advertisement, at least one still frame, moving frames, a textual advertisement, a graphical advertisement, a translucent advertisement, and a subliminal advertisement.

58. The system of claim 52, wherein the processor is further configured with the logic to insert an audio advertisement in an audio signal that is included in the trick mode display and insert a visual advertisement that is included in the trick mode display.

59. The system of claim 52, wherein the processor is further configured with the logic to determine the type of advertisement to present and how to present the advertisement.

60. The system of claim 52, wherein the processor is further configured with the logic to determine the trick mode activated, determine the characteristics of the media content that is presented in the trick mode display, and select an advertisement that has a duration that allows for recognition of the advertisement to the user during the trick mode display and that is related to the characteristics of the media content instance.

61. The system of claim 52, wherein the processor is further configured with the logic to present the advertisement in the trick mode display as an overlay.

62. A system for presenting advertisements to a user during video presentations, the system comprising:
a memory with logic; and
a processor configured with the logic to detect a trick mode button keypress indication during a media content instance presentation, the trick mode button keypress causing a trick mode display of the media content instance presentation, wherein the trick mode button includes at least one of a fast forward button, rewind button, pause button, skip ahead button, and skip back button, wherein the trick mode display includes at least one of a fast forwarding video presentation, a paused video presentation, a rewinding video presentation, a video presentation that is skipping ahead, and a video presentation that is skipping back, wherein the processor is further configured with the logic to retrieve an advertisement from a storage device in response to the trick mode activation, wherein the storage device is located in at least one of a media client device and a server device located remotely from the media client device, wherein the processor is further configured with the logic to insert the advertisement in a video signal that is included in the trick mode display, wherein the processor is further configured with the logic to insert an audio advertisement in an audio signal that is included in the trick mode display, wherein the processor is further configured with the logic to present the advertisement in the trick mode display.
